(19) United States
(12) Patent Application Publication
(10) Pub. No.: US 2026/0132489 A1
(43) Pub. Date: May 14, 2026

(54) TITANIUM ALLOY AND METHOD FOR PRODUCING TITANIUM ALLOY

(71) Applicant: NIPPON PISTON RING CO., LTD., Saitama City, Saitama (JP)

(72) Inventors: Takasumi KUBO, Saitama City, Saitama (JP); Masahiro SHINZAWA, Saitama City, Saitama (JP); Yuki KIMURA, Saitama City, Saitama (JP); Mayuki ARAI, Saitama City, Saitama (JP); Fumiya NAKAZAKI, Saitama City, Saitama (JP)

(21) Appl. No.: 18/686,285

(22) PCT Filed: Mar. 2, 2022
(86) PCT No.: PCT/JP2022/008831

§ 371 Date: Feb. 23, 2024

(30) Foreign Application Priority Data
Sep. 3, 2021 (JP) 2021-143932

(51) Int. Cl. C22C 14/00; B22F 3/10; C22C 1/02; C22C 1/04; C22F 1/18

(52) U.S. Cl. CPC C22C 14/00; B22F 3/10; C22C 1/02; C22C 1/0458; C22F 1/183; B22F 2301/205; B22F 2998/10; B22F 2999/00

(57) ABSTRACT

A titanium alloy according to the present invention contains oxygen at a content increased more than a conventional alloy. The titanium alloy includes, relative to 100 atomic % (at %) of the entire amount of the titanium alloy, 15 to 27 at % of tantalum (Ta), 1 to 8 at % of tin (Sn), 0.4 to 1.7 at % of oxygen (O), and a balance of titanium (Ti) and inevitable impurities. In the titanium alloy according to the present invention, an average particle diameter of an equiaxed α phase desirably falls within a range of 0.01 μm to 1.0 μm. In the titanium alloy according to the present invention, an area ratio at which the equiaxed α phase occupies per unit area desirably falls within a range of 0.1% to 10%.

### TECHNICAL FIELD

The present invention relates to a titanium alloy and a method for producing a titanium alloy.

### BACKGROUND ART

Conventionally, as a titanium alloy, a titanium alloy containing tantalum and tin has been proposed (for example, see Japanese Patent No. 5855588). When this titanium alloy is subjected to cold working and then to a heat treatment at a predetermined temperature, an α phase and an ω phase are changed into a β phase while a residual strain generated during the cold working is removed.

In a conventional method for producing a titanium alloy, for example, columnar titanium and an additive wire-shaped or sheet-shaped metal are placed in a crucible of a levitation melter, melted under a predetermined melting condition, and naturally cooled in the crucible, to obtain a titanium alloy (for example, see Japanese Patent Application Laid-Open No. 2002-012923). In another conventional method for producing a titanium alloy, for example, a titanium powder and a powder of a vanadium group element are mixed, placed in a heating container, and then sintered under application of pressure and heat, to obtain a titanium alloy (for example, see Japanese Patent No. 3375083).

### SUMMARY OF INVENTION

### Technical Problem

However, studies by the present inventors have revealed that the titanium alloy described in PTL 1 has properties in which yield points in two stages are generated in a stress-strain diagram when a heat treatment at 800° C. or higher is performed after cold working, resulting in a reduction in elastic limit strain. Therefore, such a titanium alloy has properties in which deformation is easily caused even by a small force. For example, when a titanium alloy bar (work) subjected to a heat treatment is further subjected to lathe turning, cutting is difficult. This difficulty is due to the titanium alloy bar being easily bent by a force when a cutting tool is brought into contact with the titanium alloy bar.

In an attempt to overcome the above-described situation, an aging treatment was tried to be performed after the heat treatment of the titanium alloy described in PTL 1, in a process of undisclosed studies by the present inventors. However, there has been a problem that an aging treatment of several days is required for precipitation of an α phase since the titanium alloy described in PTL 1 contains a large amount of tantalum that is a β stabilization element.

In view of the above-described circumstances, a first invention is intended to provide a titanium alloy containing an increased oxygen content as compared with that in a conventional one.

On the other hand, when a titanium alloy is actively made to contain oxygen, the method for producing a titanium alloy described in PTL 2 encounters difficulties in controlling the chemical composition of the titanium alloy with high precision. This difficulty is due to the elements in the air being mixed in the titanium alloy during melting. Therefore, the production method described in PTL 2 has an inherent problem that the amount of oxygen cannot be controlled.

According to studies by the present inventors, the method for producing a titanium alloy described in PTL 3 has a problem that titanium and the vanadium group element are heterogeneously diffused in the sintered titanium alloy. Therefore, the production method described in PTL 3 has a problem that oxygen contained in an oxide film of titanium powder is also heterogeneously diffused.

In view of the above-described circumstances, a second invention is intended to provide a method for producing a titanium alloy that is capable of homogenizing the whole titanium alloy while the ratios of a chemical composition contained in the titanium alloy are controlled with high precision.

### Solution to Problem

A titanium alloy according to a first invention includes, relative to 100 atomic % (at %) of the entire amount of the titanium alloy, 15 to 27 at % of tantalum (Ta), 1 to 8 at % of tin (Sn), 0.4 to 1.7 at % of oxygen (O), and a balance of titanium (Ti) and inevitable impurities.

In the titanium alloy according to the first invention, an average particle diameter of an equiaxed α phase falls within a range of 0.01 μm to 1.0 μm.

Furthermore, in the titanium alloy according to the first invention, an area occupancy at which the equiaxed α phase occupies per unit area falls within a range of 0.1% to 10%.

Furthermore, in the titanium alloy according to the first invention, when a stress at a time when a permanent set reaches 0.5% in a tensile test is defined as a stress at 0.5% strain, the stress at 0.5% strain falls within a range of 400 MPa to 1,200 MPa.

A method for producing a titanium alloy according to a second invention includes a mixing step of mixing at least a titanium powder, which contains titanium (Ti) as a main component, and a vanadium group powder, which contains a vanadium group element as a main component, to obtain a mixed powder, a solidifying step of heating the mixed powder mixed in the mixing step to cause solid-phase diffusion bonding to thereby obtain a solidified body, and a melting step of heating and melting the solidified body to generate a titanium alloy.

Furthermore, in the method for producing a titanium alloy according to the second invention, in the solidifying step, the solid-phase diffusion bonding of the mixed powder is performed by heating the mixed powder at any temperature between 900 to 1,400° C.

Furthermore, in the method for producing a titanium alloy according to the second invention, in the solidifying step, the mixed powder is placed in a vacuum environment, and the solid-phase diffusion bonding of the mixed powder is performed by heating and pressurizing the mixed powder.

Furthermore, in the method for producing a titanium alloy according to the second invention, in the melting step, the solidified body is melted by a vacuum arc remelting method or a cold crucible induction melting method.

Furthermore, in the method for producing a titanium alloy according to the second invention, the titanium alloy contains 0.4 to 1.7 at % of oxygen (O) relative to 100 atomic % (at %) of the entire amount of the titanium alloy.

Furthermore, in the method for producing a titanium alloy according to the second invention, the vanadium group powder contains tantalum (Ta) or niobium (Nb) as a main component.

Furthermore, in the method for producing a titanium alloy according to the second invention, the titanium alloy contains 1 to 8 at % of tin (Sn) relative to 100 atomic % (at %) of the entire amount of the titanium alloy.

Furthermore, the method for producing a titanium alloy according to the second invention includes a heat treating step of subjecting the titanium alloy generated in the melting step to a heat treatment, and an aging step of subjecting the titanium alloy having been subjected to the heat treatment to an aging treatment. Herein, the titanium alloy after the melting step includes, relative to 100 atomic % (at %) of the entire amount of the titanium alloy, 15 to 27 at % of tantalum (Ta), 1 to 8 at % of tin (Sn), 0.4 to 1.7 at % of oxygen (O), and the balance of titanium (Ti) and inevitable impurities.

Furthermore, in the method for producing a titanium alloy according to the second invention, the titanium alloy is subjected to an aging treatment of 24 hours or less in the aging step, so that an α phase is caused to precipitate in the titanium alloy.

### Advantageous Effects of Invention

According to the titanium alloy of the first invention, an excellent effect in which the precipitation of an equiaxed α phase can be easily controlled can be obtained. According to the method for producing a titanium alloy of the second invention, an excellent effect in which each component of the titanium alloy can be homogenized while the ratio of a chemical composition contained in the titanium alloy is controlled with high precision can be obtained. Hereinafter, the first invention and the second invention are collectively and simply called the present invention.

### BRIEF DESCRIPTION OF DRAWINGS

FIG. 1 is a Ta—Ti binary system phase diagram.

FIG. 2 is a graph showing the results of a cold workability evaluation test on titanium alloys (Ti-23Ta-xSn-0.26O) containing Ta at a content of 23 at %, Sn at a content of x (at %), and 0 at a content of 0.26 at& relative to 100 atomic % (at %) of the entire amount of each of the titanium alloys.

FIG. 3 is a table showing the results of a cold workability evaluation test on titanium alloys (Ti-23.4Ta-3.4Sn-xO) containing Ta at a content of 23.4 at %, Sn at a content of 3.4 at %, and I at a content of x (at %) relative to 100 atomic % (at %) the entire amount of each of the titanium alloys.

FIG. 4(A) is a photograph of a STEM image when a surface of a comparative example titanium alloy (Ti-23.4Ta-3.4Sn-0.26O) that is a comparative example is observed at a magnification of 2,000 with a scanning transmission electron microscope (STEM). FIG. 4(B) is a photograph of a STEM image when a surface of a first titanium alloy (Ti-23.4Ta-3.4Sn-0.75O) is observed at a magnification of 2,000 with a scanning transmission electron microscope (STEM). FIG. 4(C) is a photograph of a STEM image when a surface of a second titanium alloy (Ti-23.4Ta-3.4Sn-0.92O) is observed at a magnification of 2,000 with a scanning transmission electron microscope (STEM). Here, numerical values attached to indicated elements Ta, Sn, and O in parentheses of each of the comparative example titanium alloy, the first titanium alloy, and the second titanium alloy represent numerical values of atomic percent (at %) of each element (Ta, Sn, and O) relative to 100 atomic % (at %) of the entire amount of each of the comparative example titanium alloy, the first titanium alloy, and the second titanium alloy.

FIG. 5(A) is a photograph of a STEM image when a surface of a third titanium alloy (Ti-23Ta-3Sn-0.65O) that was subjected to an aging treatment at 400° C. for 12 hours is observed at a magnification of 2,000 with a scanning transmission electron microscope (STEM). FIG. 5(B) is a photograph of a STEM image when a surface of a third titanium alloy (Ti-23Ta-3Sn-0.65O) that was subjected to an aging treatment at 500° C. for 12 hours is observed at a magnification of 2,000 with a scanning transmission electron microscope (STEM). Here, numerical values attached to indicated elements Ta, Sn, and O in parentheses of each of the third titanium alloys represent numerical values of atomic percent (at %) of each element (Ta, Sn, and O) relative to 100 atomic % (at %) of the entire amount of each of the third example titanium alloys.

FIG. 6 is an enlarged view of a dotted-line quadrilateral region in FIG. 5(A).

FIG. 7(A) is a table showing chemical compositions of test specimens H1 and T1 formed using a titanium alloy in an embodiment of the present invention. FIG. 7(B) is a stress-strain diagram that is the result of a tensile test on each of the test specimens H1 and T1.

FIG. 8(A) is a stress-strain diagram obtained as a result by performing a tensile test in which stress-strain is repeatedly applied to the test specimen H1. FIG. 8(B) is a stress-strain diagram obtained as a result by performing a tensile test in which stress-strain is repeatedly applied to the test specimen T1. FIG. 8(C) is a diagram in which the stress-strain diagrams of FIG. 8(A) and 8(B) are superposed.

FIG. 9(A) is a table showing chemical compositions of test specimens H2 and T2 formed using a titanium alloy in an embodiment of the present invention. FIG. 9(B) is a stress-strain diagram that is the result of a tensile test on each of the test specimens H2 and T2.

FIG. 10(A) is a stress-strain diagram obtained as a result by performing a tensile test in which stress-strain is repeatedly applied to the test specimen H2. FIG. 10(B) is a stress-strain diagram obtained as a result by performing a tensile test in which stress-strain is repeatedly applied to the test specimen T2. FIG. 10(C) is a diagram in which the stress-strain diagrams of FIG. 10(A) and 10(B) are superposed.

FIG. 11(A) is a diagram in which stress-strain diagrams that are the results of a tensile test on the test specimens T1 and T2 are superposed. FIG. 11(B) is a diagram in which the stress-strain diagrams obtained as a result by performing a tensile test in which stress-strain is repeatedly applied to the test specimens T1 and T2 are superposed.

FIG. 12 is a graph showing a relationship between an oxygen content x and a stress o at a strain of 0.5% when test specimens of titanium alloys with a chemical composition of Ti-23Ta-3Sn-xO (provided that 0.4≤x≤1.7) before and after aging treatment are each subjected to a tensile test.

FIG. 13(A) is a table showing chemical compositions of test specimens H3, T3, and T4 formed using a titanium alloy in an embodiment of the present invention. FIG. 13(B) is a graph showing the results of a Vickers hardness test on the test specimens H3, T3, and T4 with heat treatment temperatures changed.

FIG. 14 is a flow chart illustrating a process flow of a method for producing a titanium alloy in an embodiment of the present invention.

FIG. 15(A) is a schematic view of an HIP device used in the method for producing a titanium alloy in the embodiment of the present invention. FIG. 15(B) is a schematic view of a device that performs vacuum arc remelting (VAR) used in the method for producing a titanium alloy in the embodiment of the present invention.

FIG. 16(A) is a photograph of a SEM image when a solidified body generated by an HIP treatment is observed at a magnification of 400 with a scanning electron microscope (SEM). FIG. 16(B) is a photograph of a SEM image when elemental analysis of Ti is performed with an X ray at a range of FIG. 16(A). FIG. 16(C) is a photograph of a SEM image when elemental analysis of Ta is performed with an X ray at the range of FIG. 16(A). FIG. 16(D) is a photograph of a SEM image when elemental analysis of Sn is performed with an X ray at the range of FIG. 16(A).

### DESCRIPTION OF EMBODIMENTS

Hereinafter, a titanium alloy in an embodiment of the present invention will be described with reference to the accompanying drawings.

### Configuration of Titanium Alloy

The titanium alloy in the embodiment of the present invention includes 15 to 27 at % of tantalum (Ta), 1 to 8 at % of tin (Sn), and 0.4 to 1.7 at % of oxygen (O) with the balance including titanium (Ti) and unavoidable impurities relative to 100 atomic % (at %) of the entire amount of the titanium alloy. The content of titanium (Ti) in the balance is not particularly limited as long as among the constituent elements, titanium (Ti) is the element having the highest atomic ratio.

Titanium alloys are broadly classified into three types: an α-type titanium alloy in which the matrix phase is an α phase of hexagonal close packed (HCP) crystals, a β-type titanium alloy in which the matrix phase is a β phase of body centered-cubic (BCC) crystals, and an α+B-type titanium alloy in which the α phase of hexagonal close-packed (HCP) crystals and the β phase of body centered-cubic (BCC) crystals coexist. The type of the titanium alloy according to the present invention is not particularly limited.

### Tantalum (Ta)

Tantalum (Ta) allows the titanium alloy in the present embodiment to undergo thermoelastic martensitic transformation. Ta has a function by which the temperature of transformation from the β phase to the α phase decreases, to stabilize the β phase at room temperature, and a function of inhibiting slip deformation (plastic deformation).

The content of Ta is preferably 15 to 27 at %, more preferably 19 to 25 at %, and most preferably 22 to 24 at %, relative to 100 atomic % (at %) of the entire amount of the titanium alloy.

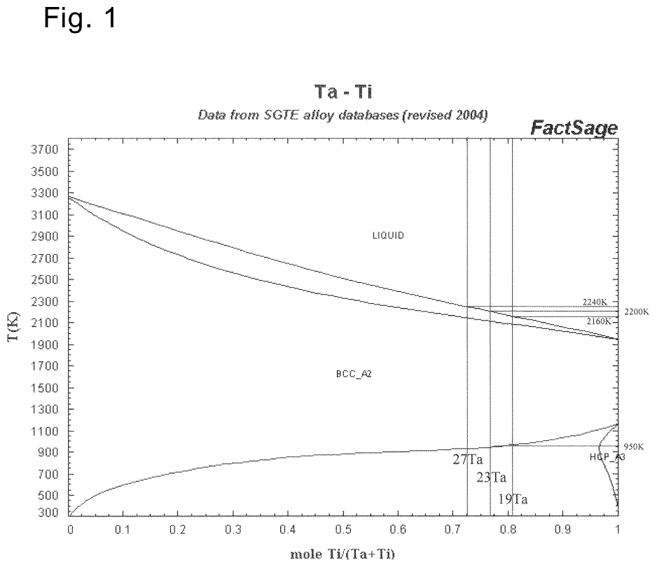

The upper limit value of the content of Ta is set on the basis of the melting point of the titanium alloy. FIG. 1 is a Ta—Ti binary system phase diagram. As shown in FIG. 1, when the content of Ta exceeds 27%, the melting point of the titanium alloy can be about 2,000 K or higher. Therefore, a special melting furnace is required, and the production cost increases. In addition, a Ta raw material may not be completely melted, leading to a reduction in the quality of the titanium alloy.

The lower limit value of the content of Ta is set on the basis of the above-described β phase stabilization function and the mechanical properties of the titanium alloy as medical device materials, biocompatible materials, and the like. That is, as the content of Ta decreases, the β phase stabilization function decreases. When the content of Ta is less than 15 at %, it is difficult to maintain the β phase until normal temperature. Therefore, when the content of Ta is less than 15 at %, it is difficult to obtain the mechanical properties (Young's modulus, tensile strength, and elastic deformation strain) required for medical device materials, biocompatible materials, and the like even with addition of tin (Sn). Accordingly, the content of Ta relative to 100 atomic % (at %) of the entire amount of the titanium alloy is preferably 15 at % or more, more preferably 19 at % or more, and the most preferably 22 at % or more.

### Tin (Sn)

Tin (Sn) has an α phase stabilization function that increases the transformation temperature and stabilizes the α phase. Sn has a function of suppressing precipitation of an ω phase that may cause an increase in Young's modulus and improving the superelastic effect of the titanium alloy.

The content of Sn is preferably 1 to 8 at %, more preferably 2 to 6 at %, relative to 100 atomic % (at %) of the entire amount of the titanium alloy.

The upper limit value of the content of Sn is set on the basis of the workability (cold workability) of the titanium alloy. A graph shows the results of a cold workability evaluation test on titanium alloys (Ti-23Ta-xSn-0.26O) containing Ta at a content of 23 at % relative to 100 at % of the entire amount of the titanium alloy. “x” is the content (at %) of Sn relative to 100 at % of the entire amount of the titanium alloy. In the cold workability evaluation test, a plurality of test specimens (thickness: 1 mm, no heat treatment) in which the content x of Sn is changed to 0 at %, 1.5 at %, 3 at %, 6 at %, and 9 at % relative to 100 at % of the entire amount of each of the titanium alloys were prepared. Each of the test specimens was cold-rolled (working rate: 86%) to a thickness of 0.1 mm, and the number of cracks having a length of 1 mm or more in each of the cold-rolled test specimens was counted. The number of cracks across a range of 140 mm in the rolling direction was counted for each of the test specimens.

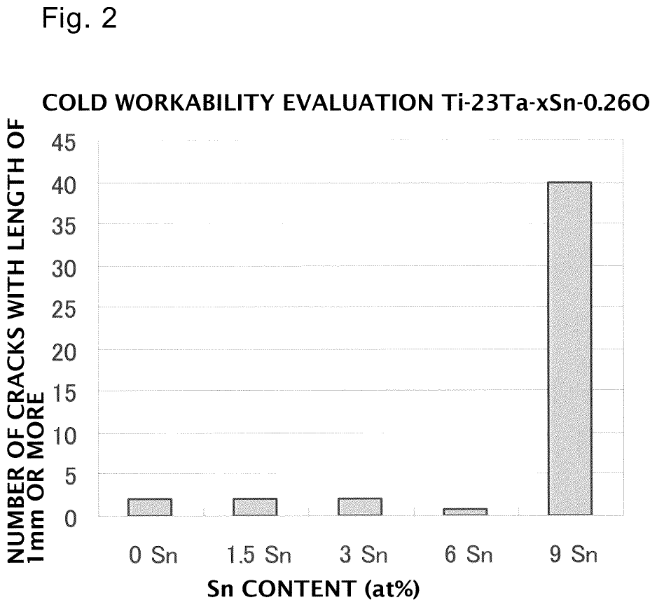

As shown in FIG. 2, the results of the evaluation test show that when the content of Sn is 9 at %, the occurrence of cracks having a length of 1 mm or more sharply increases, that is, the workability sharply decreases. Even when the content of Ta is different, the result has a similar trend. Therefore, the content of Sn relative to 100 at % of the entire amount of the titanium alloy is preferably 8 at % or less, and more preferably 6 at % or less in terms of achieving favorable workability.

The lower limit value of the content of Sn is not particularly limited. In order to sufficiently exert the above-described ω phase suppression function, the content of Sn relative to 100 at % of the entire amount of the titanium alloy is preferably 1 at % or more.

### Oxygen (O)

Oxygen (O) has an α phase stabilization function that increases the transformation temperature and stabilizes the α phase. The α phase stabilization function of O is more effective than that of Sn. Furthermore, oxygen (O) has a function of constraining the deformation of crystals, and this function prevents the expression of shape memory and softening.

The content of O is preferably 0.4 to 1.7 at %, and more preferably 0.6 to 1.0 at %, relative to 100 atomic % (at %) of the entire amount of the titanium alloy.

### Upper Limit of Content of O (Evaluation of Cold Workability)

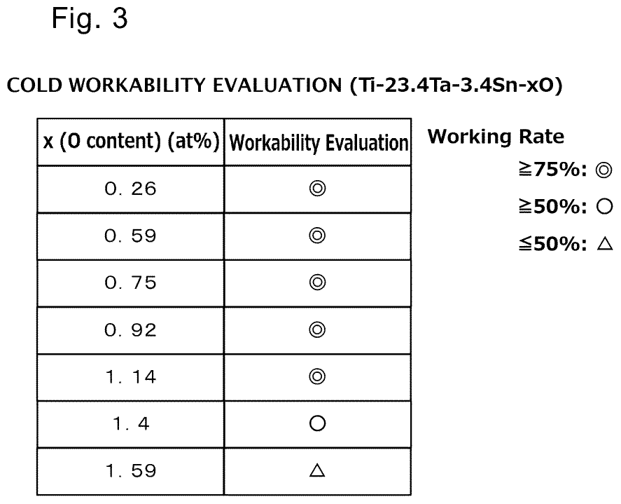

The upper limit value of the content of O is set on the basis of the workability (cold workability) of the titanium alloy. When the content of O is too high, the titanium alloy is too hard due to the softening prevention function of O, and workability is thus impaired. FIG. 3 is a table showing the results of a cold workability evaluation test on titanium alloys (Ti-23.4Ta-3.4Sn-xO) containing Ta at a content of 23.4 at % and Sn at a content of 3.4 at % relative to 100 at % of the entire amount of each of the titanium alloys. “x” is the content (at %) of O relative to 100 at % of the entire amount of the titanium alloy. The titanium alloys used in the cold workability evaluation test are alloys produced by <Method for Producing Titanium Alloy> described below.

In the cold workability evaluation test, a plurality of test specimens (a round wire shape having a diameter φ of 10 mm, no heat treatment) in which the content x of O is changed to 0.26 at %, 0.59 at %, 0.75 at %, 0.92 at %, 1.14 at %, 1.4 at %, and 1.59 at % relative to 100 at % of the entire amount of each of the titanium alloys (Ti-23.4Ta-3.4Sn-xO) were prepared. The test specimens were subjected to roll forging, during which evaluation was performed on each of the test specimens in terms of at what working rate roll forging can be performed.

As shown in FIG. 3, the results of the evaluation test show that the test specimens in which the content of O is 0.26 to 1.14 at % had no problem even when roll forging was performed at a working rate of 75% or more. The test specimen in which the content of O is 1.4 at % had no problem even when roll forging was performed at a working rate of 50 to 75%, but was cracked when the working rate exceeded 75%. The test specimen in which the content of 0 is 1.59 at % was cracked when roll forging was performed at a working rate of more than 50%. Therefore, the content of 0 relative to 100 at % of the entire amount of the titanium alloy is preferably 1.7 at % or less, more preferably 1.4 at % or less, and still more preferably 1.2 at % or less in terms of achieving favorable workability.

### Lower Limit of Content of O (Evaluation of Composition of Titanium Alloy)

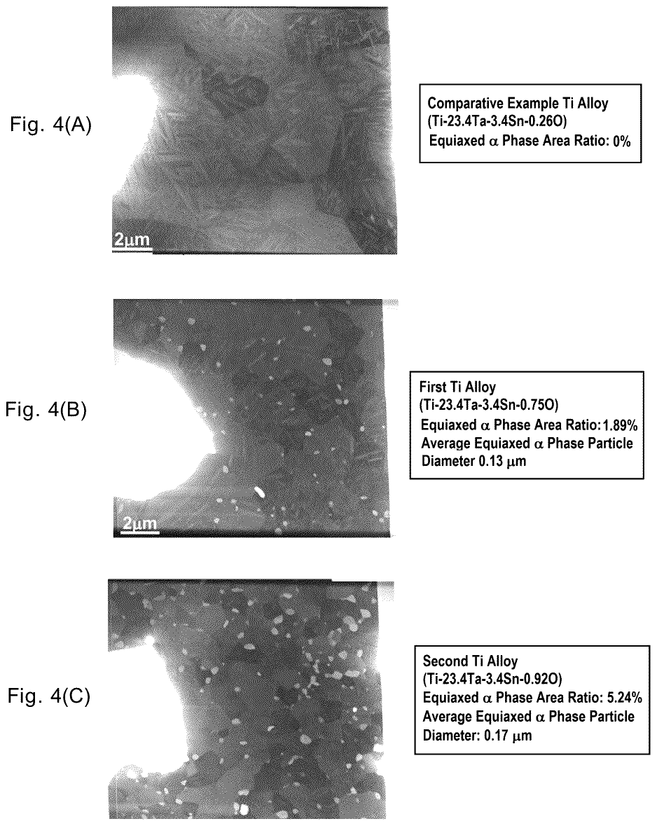

The lower limit value of the content of O is set particularly on the basis of the mechanical properties. Since a conventional titanium alloy has a large amount of β phase and is deformed by a small force, the titanium alloy has a problem that the shape after molding cannot be maintained. Accordingly, it is preferable that in the titanium alloy of the embodiment, an equiaxed α phase having a function that constrains the deformation of crystals and thereby enhances the strength of the alloy and prevents softening be precipitated in a certain amount. In the titanium alloy in the present embodiment, an equiaxed α phase is precipitated by performing cold working, a heat treatment, and then an aging treatment, as described in <Method for Producing Titanium Alloy> described below. For example, the heat treatment temperature is preferably within the range of 600° C. to 1,000° C., and more preferably within the range of 700° C. to 900° C. The aging treatment temperature is preferably within the range of 200° C. to 550° C., and more preferably within the range of 300° C. to 500° C. However, when the content of O in the titanium alloy is not sufficient, Ta exhibits its functions as a β stabilizing element to a larger degree than O does as an α stabilizing element. In such a case, an equiaxed α phase is not easily precipitated even by performing an aging treatment. In some cases, the precipitation of the equiaxed α phase may require an aging treatment over several days. When the content of 0 is less than 0.4 at %, the amount of the equiaxed α phase precipitated by performing an aging treatment of about 2 hours is not sufficient, like a comparative example titanium alloy (Ti-23.4Ta-3.4Sn-0.26O) in FIG. 4(A) described below. Therefore, it is difficult to maintain the shape after molding. Accordingly, the content of O relative to 100 at % of the entire amount of the titanium alloy is preferably 0.4 at or more, more preferably 0.6 at % or more, and the most preferably 0.75 at % or more.

FIGS. 4(B) and 4(C) are photographs of STEM images when surfaces of a first titanium alloy (Ti-23.4Ta-3.4Sn-0.75O) and a second titanium alloy (Ti-23.4Ta-3.4Sn-0.92O) are observed at a magnification of 2,000 with a scanning transmission electron microscope (STEM). FIG. 4(A) is a photograph of a STEM image of the comparative example titanium alloy (Ti-23.4Ta-3.4Sn-0.26O) that is a comparative example under the same condition as described above. The first titanium alloy, the second titanium alloy, and the comparative example titanium alloy were subjected to a heat treatment at 700° C. for 2 hours and then an aging treatment at 300° C. for 2 hours.

According to the photographs of the STEM images of the first titanium alloy and the second titanium alloy shown in FIGS. 4(B) and 4(C), an equiaxed α phase (see white granular parts in the photographs of FIGS. 4(B) and 4(C)) is precipitated. In the photograph shown in FIG. 4(C) in which the content of O is high, a larger amount of the equiaxed α phase is precipitated than that in the photograph shown in FIG. 4(B). On the other hand, in the photograph of the STEM image of the comparative example titanium alloy shown in FIG. 4(A), there is not a white part corresponding to an equiaxed α phase, and the equiaxed α phase is hardly precipitated. It was confirmed that in the titanium alloy in which the content of O is high like those shown in FIGS. 4(B) and 4(C), the equiaxed α phase is precipitated even by an aging treatment of about 2 hours, but in the titanium alloy in which the content of O is low as shown in FIG. 4(A), the equiaxed α phase is not precipitated by an aging treatment of about 2 hours.

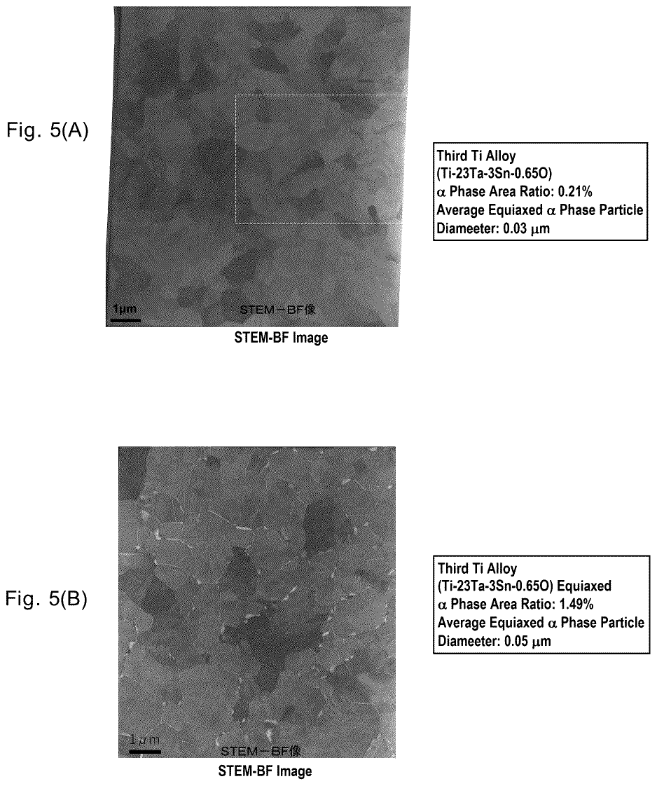

FIGS. 5(A) and 5(B) each represent a photograph of a STEM image when a surface of a third titanium alloy (Ti-23Ta-3Sn-0.65O) is observed at a magnification of 2,000 with a scanning transmission electron microscope (STEM). The third titanium alloy shown in FIG. 5(A) is subjected to a heat treatment at 900° C. for 2 hours and then an aging treatment at 400° C. for 12 hours. The third titanium alloy shown in FIG. 5(B) is subjected to a heat treatment at 900° C. for 2 hours and then an aging treatment at 500° C. for 12 hours. The third titanium alloy is produced by <Method for Producing Titanium Alloy> described below.

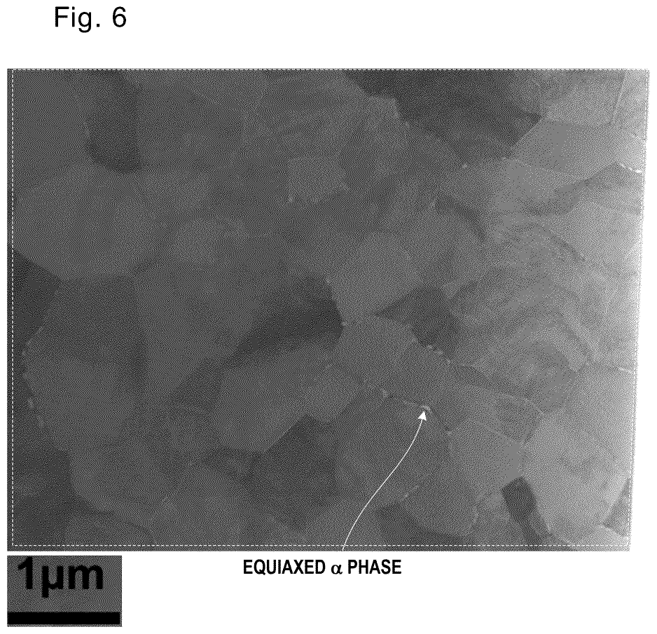

According to the photographs of the STEM images of the third titanium alloy shown in FIGS. 5(A), 5(B), and 6, an equiaxed α phase (see white granular parts) is precipitated. FIG. 6 is an enlarged view of a quadrilateral region in FIG. 5(A). The white part in FIG. 6 represents the equiaxed α phase. The equiaxed α phase in FIG. 5(A) can be confirmed by referring to FIG. 6. In the photograph (the third titanium alloy having been subjected to an aging treatment at 500° C. for 12 hours) shown in FIG. 5(B), a larger amount of equiaxed α phase (see the white parts in the photographs of FIG. 5(A) and 5(B)) is precipitated than that in the photograph (the third titanium alloy having been subjected to an aging treatment at 400° C. for 12 hours) shown in FIG. 5(A). It was confirmed from these results that a larger amount of equiaxed α phase is precipitated at a higher aging treatment temperature.

From the above results, it was confirmed that the precipitation amount of the equiaxed α phase in the titanium alloy can be controlled by the content of O, the time of the aging treatment, and the aging treatment temperature. This also shows that the content of O relative to 100 at % of the entire amount of the titanium alloy is preferably 0.4 at % or more, more preferably 0.6 at % or more, and most preferably 0.75 at % or more.

A comparison of the first titanium alloy and the second titanium alloy with the third titanium alloy shows that the amount of equiaxed α phase precipitated in the first titanium alloy and the second titanium alloy is larger than that in the third titanium alloy. This is because as follows. Since the first titanium alloy and the second titanium alloy were subjected to a heat treatment at a temperature (700° C.) corresponding to an α+β phase region of the first titanium alloy and the second titanium alloy and then to an aging treatment, the precipitation of the α phase was promoted. Since the third titanium alloy was subjected to a heat treatment at a temperature (900° C.) corresponding to a β phase region of the third titanium alloy and then to an aging treatment, the precipitation of the α phase was not promoted. Therefore, the amount of the α phase precipitated can be adjusted according to the heat treatment temperature before the aging treatment. Specifically, when the phase state of the titanium alloy is controlled by a heat treatment, the amount of the α phase precipitated by the aging treatment can be controlled. Incidentally, the heat treatment before the aging treatment may or may not be performed.

The analysis result of the photograph of the STEM image of the first titanium alloy shown in FIG. 4(B) showed that the average particle diameter of the equiaxed α phase in the first titanium alloy (Ti-23.4Ta-3.4Sn-0.75O) was 0.13 μm. The analysis result of the photograph of the STEM image of the second titanium alloy shown in FIG. 4(C) showed that the average particle diameter of the equiaxed α phase in the second titanium alloy (Ti-23.4Ta-3.4Sn-0.92O) was 0.17 μm. From the results, it can be presumed that with the increased content of O, the average particle diameter of the equiaxed α phase precipitated by the aging treatment tends to increase.

The analysis result of the photograph of the STEM image of the third titanium alloys shown in FIG. 5(A) showed that the average particle diameter of the equiaxed α phase in the third titanium alloy (Ti-23Ta-3Sn-0.65O) that had been subjected to the aging treatment performed at 400° C. for 12 hours was 0.03 μm. Furthermore, the analysis result of the photograph of the STEM image of the third titanium alloys shown in FIG. 5(B) showed that the average particle diameter of the equiaxed α phase in the third titanium alloy (Ti-23Ta-3Sn-0.65O) that had been subjected to the aging treatment at 500° C. for 12 hours was 0.05 μm. From this result, it can be presumed that with increased aging treatment temperature, the average particle diameter of the equiaxed α phase precipitated tends to increase.

Then, in the titanium alloy of the present invention, the average particle diameter P of the equiaxed α phase is preferably within the range of 0.01 μm to 1.00 μm (0.01 μm≤P≤1.00 μm), more preferably within the range of 0.02 μm to 0.50 μm (0.02 μm≤P≤0.50 μm), and even more preferably within the range of 0.03 μm to 0.30 μm (0.03 μm≤P≤0.30 μm).

The analysis result of the photograph of the STEM image of the first titanium alloy shown in FIG. 4(B) showed that the area ratio of the equiaxed α phase in the first titanium alloy (Ti-23.4Ta-3.4Sn-0.75O) was 1.89%. The area ratio of the equiaxed α phase in the second titanium alloy (Ti-23.4Ta-3.4Sn-0.92O) shown in FIG. 4(C) was 5.24%. The area ratio of the equiaxed α phase refers to the ratio (area occupancy) of the area occupied by the equiaxed α phase per unit area in the photographs of the STEM images of cross sections shown in FIGS. 4(B) and 4(C). From the results, it can be estimated that with the increased content of O, the area occupancy of the equiaxed α phase precipitated by the aging treatment increases. Herein, in the photograph of the STEM image of the comparative example titanium alloy (Ti-23.4Ta-3.4Sn-0.26O) shown in FIG. 4(A), an equiaxed α phase was not confirmed. Therefore, the area ratio of the equiaxed α phase in the comparative example titanium alloy was 0%.

The analysis result of the photograph of the STEM image of the third titanium alloy shown in FIG. 5(A) showed that the area ratio of the equiaxed α phase in the third titanium alloy (Ti-23Ta-3Sn-0.65O) that had been subjected to the aging treatment performed at 400° C. for 12 hours was 0.21%. The area ratio of the equiaxed α phase in the third titanium alloy (Ti-23Ta-3Sn-0.65O) that had been subjected to the aging treatment performed at 500° C. for 12 hours as shown in FIG. 5(B) was 1.49%. From the results, it can be presumed that with an increase in the aging treatment temperature, the area occupancy of the equiaxed α phase precipitated by the aging treatment increases.

As a result of analysis by the present inventors based on the above-described results, it was confirmed that the area occupancy Q of the equiaxed α phase in the titanium alloy of the present invention is preferably within the range of 0.1% to 10% (0.1%<Q<10%), more preferably within the range of 0.1% to 8% (0.1%<Q<8%), and further preferable within the range of 0.1% to 6% (0.1%<Q<6%). Here, the titanium alloy of the present disclosure is composed of 15 to 27 at % of tantalum (Ta), 1 to 8 at % of tin (Sn), 0.4 to 1.7 at % of oxygen (O), and the balance of titanium (Ti) and inevitable impurities.

As described above, when the same aging treatment time is used but the content of O in the titanium alloy is high, the amount of the equiaxed α phase precipitated is large. When the content of O in the titanium alloy is low, the amount of the equiaxed α phase precipitated is small. Therefore, in order to precipitate a specific amount of the equiaxed α phase in the titanium alloy by an aging treatment, the aging treatment of the titanium alloy in which the content of O is high is completed in a shorter time than that of the titanium alloy in which the content of O is low. When the chemical compositions of titanium alloys are the same as each other but the aging treatment temperature is high, the amount of the equiaxed α phase precipitated is large. When the aging treatment temperature is low, the amount of the equiaxed α phase precipitated is small.

The equiaxed α phase increases the strength of the titanium alloy. However, when the content of O is too high, it exceeds the solid solubility limit of O, and Tio and TiO₂ are generated, resulting in a reduction in workability. This is confirmed in the cold workability evaluation test shown in FIG. 3.

Although a general titanium alloy also contains a slight amount of oxygen as an inevitable impurity, the content of O relative to 100 at % of the entire amount of the titanium alloy is 0.2 at % or less. In such a titanium alloy, Ta functions as a β stabilizing element to a larger degree than O does as an α stabilizing element. Thus, an equiaxed α phase is not easily precipitated even by performing an aging treatment, and the precipitation of the equiaxed α phase requires an aging treatment over several days. On the other hand, like the titanium alloy of the present embodiment, when the content of O is increased and reaches 0.4 at %, O as an a stabilizing element functions. Thus, a minimum amount of the equiaxed α phase is precipitated by the aging treatment of 12 hours, and a sufficient amount of the equiaxed α phase is precipitated by the aging treatment of 24 hours. Furthermore, when the content of O in the titanium alloy reaches 1.7 at %, O as an α stabilizing element functions sufficiently, and a sufficient amount of the equiaxed α phase is precipitated even by the aging treatment of 1 hour. Therefore, the aging treatment time is preferably within the range of 1 to 24 hours, and more preferably within the range of 1 to 4 hours.

The titanium alloy according to the present invention is an alloy in which the amounts of dissolution of metal ions of constituent elements, Ti, Ta, and Sn, are very small, which has high corrosion resistance, low cytotoxicity, and high biocompatibility, which is non-magnetic material unlikely to be magnetized by an external magnetic field and is very unlikely to adversely affect medical devices (such as MRI) that should be free from magnetism, and which has high elasticity, appropriate stiffness, and high workability. More specifically, the titanium alloy according to the present invention is a titanium alloy having lower cytotoxicity, higher magnetic properties, higher corrosion resistance, higher mechanical properties, and higher workability than those of the conventional titanium alloys. Therefore, the titanium alloy is suitable for medical tools in the catheter field such as a guidewire, a delivery wire, a stent, an aneurysm embolization coil, and a vein filter for medical care, medical tools in the dental field such as a cleanser, a reamer, a file, and an orthodontic wire for dental treatment, and medical tools in the orthopedic field such as an artificial bone.

Of course, the titanium alloy according to the present invention is not limited to the above-described embodiments, and various modifications can be added thereto without departing from the scope of the present invention. For example, a conventionally known method can be used as a method for forming tools in the catheter field such as a guidewire, a delivery wire, a stent, an aneurysm embolization coil, or a vein filter for medical care, tools in the dental field such as a cleanser, a reamer, a file, or an orthodontic wire for dental treatment, tools in the orthopedic field such as an artificial bone, or the like from the titanium alloy according to the present invention. Examples of the methods include a wire drawing processing, a drawing processing, casting, forging, and a press working.

### Example 1

Next, examples of the titanium alloy according to the present invention will be described. The following test specimens T1 to T4 and H1 to H3 were produced by <Method for Producing Titanium Alloy> described below.

### Tensile Test 1

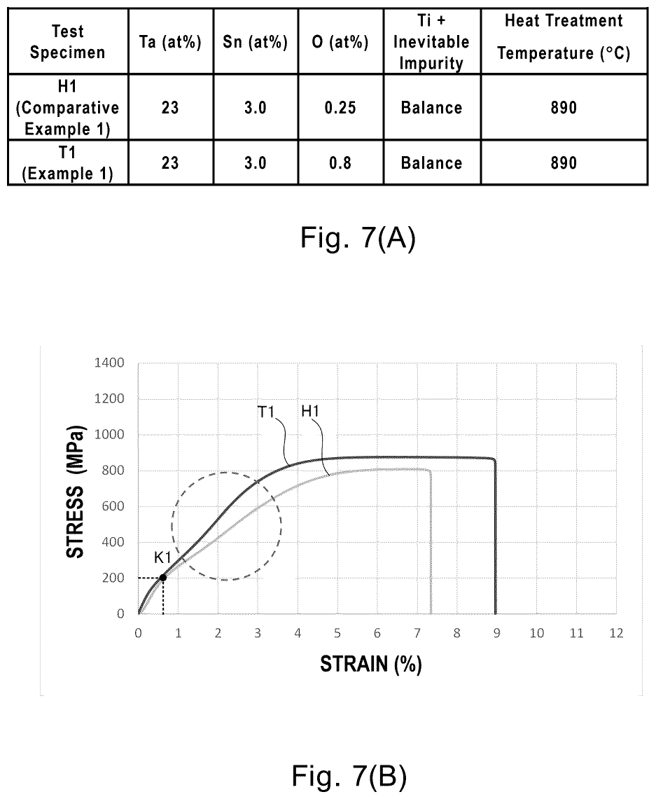

The inventors of the present application performed a tensile test on the test specimen T1 of Example 1 that was produced using the titanium alloy in the embodiment of the present invention in which the content of O was changed and on the test specimen H1 of Comparative Example 1. FIG. 7(A) is a table showing the chemical compositions of the test specimens T1 and H1 that are each a subject undergoing the tensile test. The test specimens T1 and H1 each have a round wire shape with a diameter φ of 0.406 mm that have been subjected to cold working (wire drawing) at a working rate of 75%. The test specimen H1 of Comparative Example 1 was produced using a titanium alloy with a chemical composition of Ti-23Ta-3Sn-0.25O and thus had a low content of O. The test specimen T1 of Example 1 was produced using a titanium alloy with a chemical composition of Ti-23Ta-3Sn-0.8O. The titanium alloys constituting the test specimens T1 and H1 were subjected to a heat treatment at 890° C. for 1 minute and were not subjected to an aging treatment. On the test specimens T1 and H1, the tensile test was performed with a tensile tester. The measurement conditions included a gauge length of 50 mm and a tensile rate of 2 mm/minute.

FIG. 7(B) shows a stress-strain diagram obtained as a result of the tensile test on the test specimens T1 and H1. The deformation of the test specimens T1 and H1 generated a similar strain until a stress of about 200 MPa. In the graph, there is an inflection point K1 at a stress of about 200 MPa. As shown in FIG. 7(B), the slope of the graph of the test specimen H1 past the inflection point K1 is much gentler than that before the inflection point K1. It is presumed that the test specimen H1 has a yield region on the way (see a dotted-line circle region of FIG. 7(B)). As shown in FIG. 7(B), the slope of the graph of the test specimen T1 past the inflection point K1 is gentler than that before the inflection point K1, but the slope of the graph of the test specimen T1 is steeper than that of the graph of the test specimen H1 (see the dotted-line circle region of FIG. 7(B)). Therefore, it can be said that regardless of the presence or absence of an aging treatment, the test specimen T1 of Example 1 in which the content of O is high has harder material properties (is unlikely to yield) than the test specimen H1 of Comparative Example 1, and that the shape of a molded product can be made stable.

### Tensile Test 2

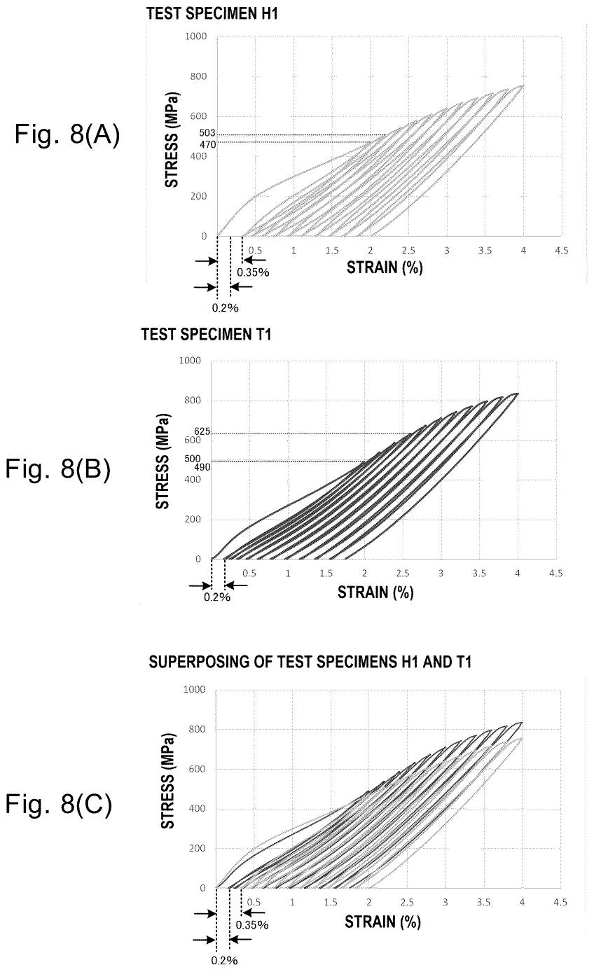

FIG. 8(A) is a stress-strain diagram obtained as a result by performing a tensile test in which stress-strain is repeatedly applied to the test specimen H1 of Comparative Example 1 under the same measurement conditions as those in the tensile test 1. FIG. 8(B) is a stress-strain diagram obtained as a result by performing a tensile test in which stress-strain is repeatedly applied to the test specimen T1 of Example 1 under the same measurement conditions as those in the tensile test 1. FIG. 8(C) is a diagram in which the stress-strain diagrams of FIGS. 8(A) and 8(B) are superposed. As seen from FIGS. 8(A) and 8(C), when the test specimen H1 is distorted by about 0 to 2% under application of a tensile stress of 470 (MPa) and then unloaded, a permanent set of about 0.35% remains. On the other hand, as seen from FIGS. 8(B) and 8(C), when the test specimen T1 is distorted by about 0 to 2% under application of a tensile stress of 490 (MPa) and then unloaded in a similar manner, a permanent set of about 0.2% only remains. Therefore, it was confirmed that the elastic limit strain of the test specimen T1 of Example 1 in which the content of O was increased was higher than that of the test specimen H1 of Comparative Example 1.

As seen from FIGS. 8(A) and 8(C), when the test specimen H1 is distorted by about 0 to 2.2% under application of a tensile stress of 503 (MPa) and then unloaded, a permanent set of about 0.5% remains. On the other hand, as seen from FIGS. 8(B) and 8(C), in order for a permanent set of about 0.5% to remain in the test specimen T1, it is necessary to distort the test specimen T1 by about 0 to 2.6% under application of a tensile stress of 625 (MPa) followed by unloading. Therefore, it was confirmed that the elastic limit strain of the test specimen T1 of Example 1 in which the content of O was increased was higher than that of the test specimen H1 of Comparative Example 1.

### Example 2

### Tensile Test 3

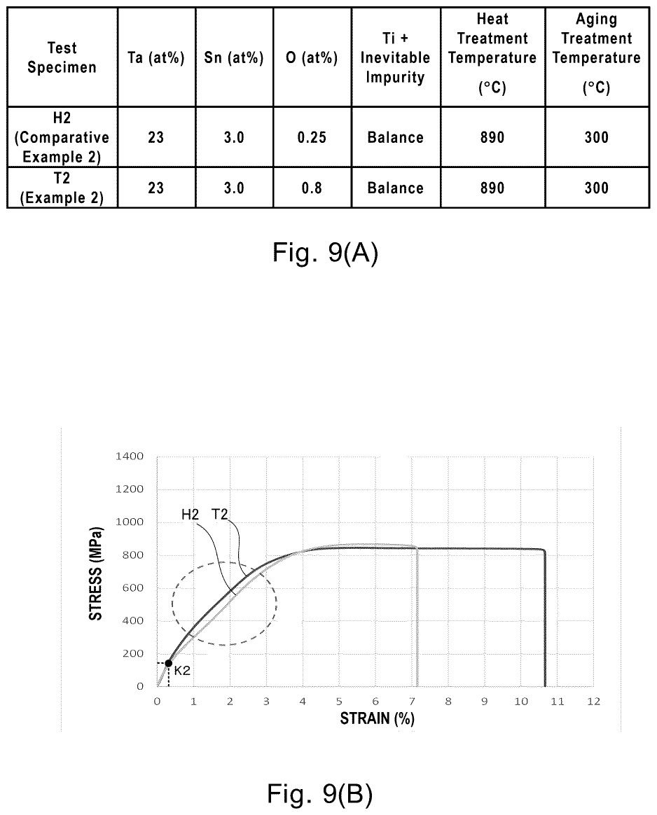

The inventors of the present application performed a tensile test on the test specimen T2 of Example 2 that was produced using the titanium alloy in the embodiment of the present invention in which the content of O was changed and on the test specimen H2 of Comparative Example 2. FIG. 9(A) is a table showing the chemical compositions of the test specimens T2 and H2 that are each a subject undergoing the tensile test. The chemical compositions of the titanium alloys constituting the test specimens T2 and H2 were formed by further performing an aging treatment at 300° C. for 1 hour on the titanium alloys constituting the test specimen T1 of Example 1 and the test specimen H1 of Comparative Example 1. On the test specimens T2 and H2, the tensile test was performed with a tensile tester. The measurement conditions included a gauge length of 50 mm and a tensile rate of 2 mm/minute.

FIG. 9(B) shows a stress-strain diagram obtained as a result of the tensile test on the test specimens T2 and H2. The test specimens T2 and H2 are deformed so as to generate a similar strain until a stress of about 200 MPa. In the graph, there is an inflection point K2 at a stress of about 200 MPa. As shown in FIG. 9(B), the slope of the graph of the test specimen H2 past the inflection point K2 is much gentler than that before the inflection point K2 (see a dotted-line circle region of FIG. 9(B)). As shown in FIG. 9(B), the slope of the graph of the test specimen T2 past the inflection point K2 is gentler than that before the inflection point K2, but the slope of the graph of the test specimen T2 is steeper than that of the graph of the test specimen H2 (see the dotted-line circle region of FIG. 9(B)). Therefore, it can be said that the test specimen T2 has harder material properties (is unlikely to yield) than the test specimen H2, and that the shape of a molded product can be made stable.

A comparison of the test specimens T2 and H2 with the test specimens T1 and H1 shows that the degree of the slopes of the graphs of the test specimens T2 and H2 past the inflection point are steeper than those of the test specimens T1 and H1. This is due to properties of rigid metal since the titanium alloy having been subjected to an aging treatment contains a larger amount of the equiaxed α phase as compared with the titanium alloy not subjected to an aging treatment. Therefore, it can be said that the titanium alloy of the embodiment having been subjected to an aging treatment is easily molded after cold working.

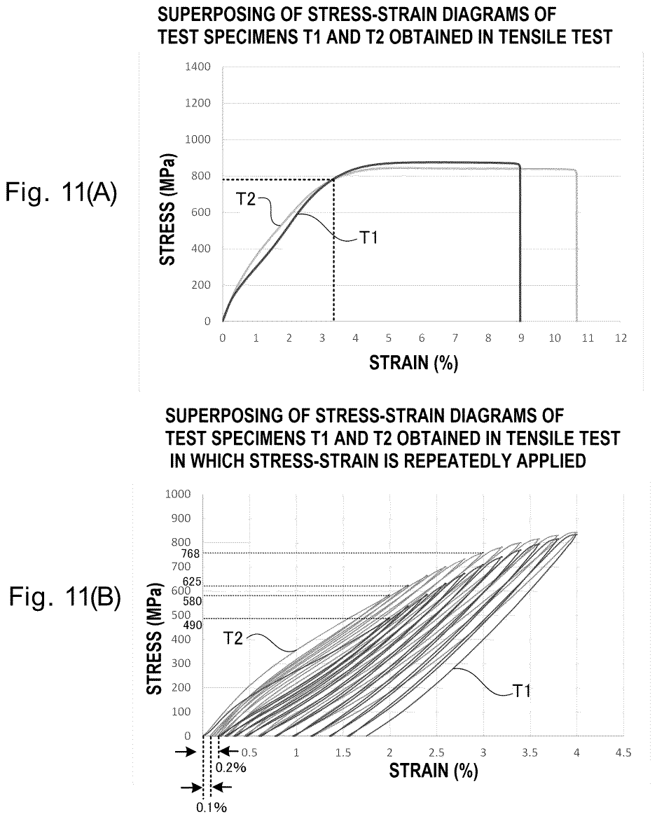

In addition, a comparison of the result (see FIG. 7(B)) of the tensile test 1 on the test specimen 1 of Example 1 with the result (see FIG. 9(B)) of the tensile test 3 on the test specimen T2 of Example 2 shows that as shown in FIG. 11(A), the test specimen T2 is less distorted than the test specimen T1 under application of the same stress within a section until a stress of slightly less than 800 (MPa) where the graphs intersect each other. After the stresses of the test specimens T1 and T2 reach the maximum values (tensile strengths), in both the test specimens T1 and T2, the stresses (tensile strengths) are nearly constant and the strains increase. The maximum value (tensile strength) of the stress of the test specimen T1 is about 870 (MPa), and the maximum value (tensile strength) of the stress of the test specimen T2 is about 840 (MPa). In the test specimen T2, the strain resulting in a rupture is about 1.2 times larger than that in the test specimen T1. It can be said that the results show that the titanium alloy having been subjected to an aging treatment allows a larger amount of the equiaxed α phase to be precipitated as compared with the titanium alloy not subjected to an aging treatment, and show harder properties, and ductility is enhanced.

### Tensile Test 4

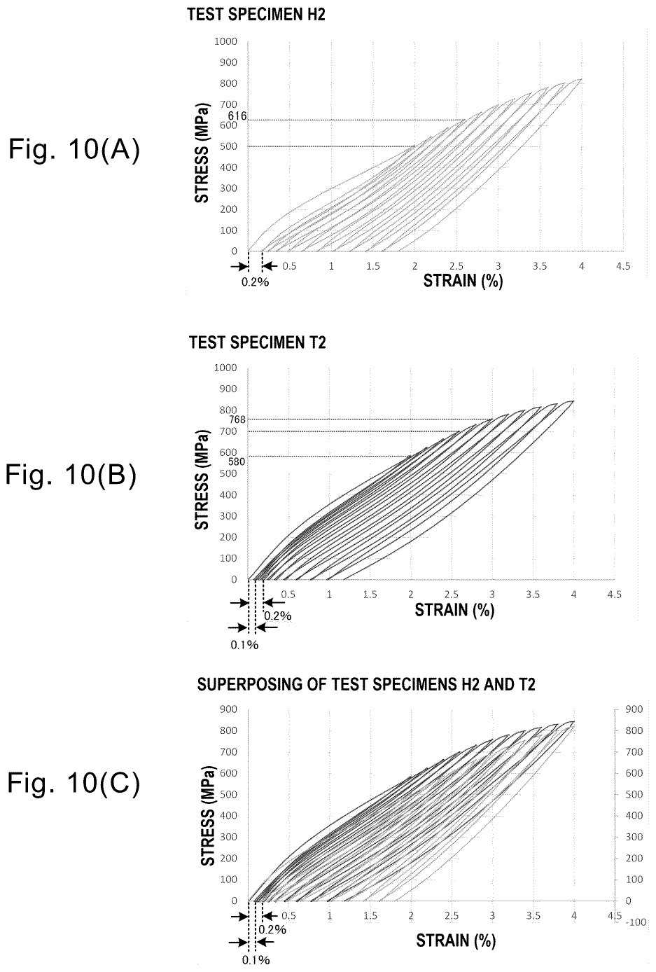

FIG. 10(A) is a stress-strain diagram obtained as a result by performing a tensile test in which stress-strain is repeatedly applied to the test specimens H2 under the same measurement conditions as those in the tensile test 3. FIG. 10(B) is a stress-strain diagram obtained as a result by performing a tensile test in which stress-strain is repeatedly applied to the test specimens T2 under the same measurement conditions as those in the tensile test 3. FIG. 10(C) is a diagram in which the stress-strain diagrams of FIGS. 10(A) and 10(B) are superposed. As seen from FIGS. 10(A) and 10(C), when the test specimen H2 is distorted by about 0 to 2% under application of a tensile stress of slightly less than 500 (MPa) and then unloaded, a permanent set of about 0.2% remains. On the other hand, as seen from FIGS. 10(B) and 10(C), when the test specimen T2 is distorted by about 0 to 2% under application of a tensile stress of 580 (MPa) and then unloaded in a similar manner, a permanent set of slightly less than 0.1% only remains. Therefore, it was confirmed that the elastic limit strain of the test specimen T2 in which the content of O was increased was higher than that of the test specimen H2.

As seen from FIGS. 10(A) and 10(C), when the test specimen H2 is distorted by about 0 to 2.6% under application of a tensile stress of 616 (MPa) and then unloaded, a permanent set of about 0.5% remains. On the other hand, as seen from FIGS. 10(B) and 10(C), in order for a permanent set of about 0.5% to remain in the test specimen T2, it is necessary to distort the test specimen T2 by about 0 to 3.0% under application of a tensile stress of 768 (MPa) followed by unloading. Therefore, it was confirmed that the elastic limit strain of the test specimen T2 of Example 2 in which the content of O was increased was higher than that of the test specimen H2 of Comparative Example 2.

In addition, a comparison of the result (see FIG. 8(B)) of the tensile test 2 on the test specimen T1 of Example 1 with the result (see FIG. 10(B)) of the tensile test 4 on the test specimen T2 of Example 2 shows that as shown in FIG. 11(B), for example, when the test specimen T1 not subjected to an aging treatment is distorted by about 2% under application of a tensile stress of about 490 (MPa) and then unloaded, a strain of 0.2% is generated, but when the test specimen T2 having been subjected to an aging treatment is distorted by about 2% under application of a tensile stress of about 580 (MPa) and then unloaded, a strain of slightly less than 0.1% is only generated. Therefore, it can be said that the titanium alloy having been subjected to an aging treatment has a higher elastic limit strain than the titanium alloy not subjected to an aging treatment.

As shown in FIG. 11(B), when the test specimen T1 not subjected to an aging treatment is distorted by about 2.6% under application of a tensile stress of about 625 (MPa) and then unloaded in a similar manner, a strain of 0.5% is generated. However, when the test specimen T2 subjected to an aging treatment is distorted by about 3% under application of a tensile stress of about 768 (MPa) and then unloaded, a strain of 0.5% is generated. Therefore, it can be said that the titanium alloy having been subjected to an aging treatment has a higher elastic limit strain than the titanium alloy not subjected to an aging treatment.

Herein, the stress when the permanent set reaches 0.5% in the tensile test is defined to be a stress σ (MPa) at a strain of 0.5%. As seen from FIG. 8(B), the stress σ at a strain of 0.5% in the test specimen T1 is 625 (MPa). As seen from FIG. 10(B), the stress σ at a strain of 0.5% in the test specimen T2 is 768 (MPa). Therefore, in the titanium alloy with a chemical composition of Ti-23Ta-3Sn-0.8O, the stress σ at a strain of 0.5% before and after the aging treatment is any value within the range of 625 to 768 (MPa).

On the other hand, as seen from FIG. 8(A), the stress σ at a strain of 0.5% in the test specimen H1 is 503 (MPa). As seen from FIG. 10(A), the stress σ at a strain of 0.5% in the test specimen H2 is 616 (MPa). Therefore, in the titanium alloy with a chemical composition of Ti-23Ta-3Sn-0.25O, the stress σ at a strain of 0.5% before and after the aging treatment is any value within the range of 503 to 616 (MPa).

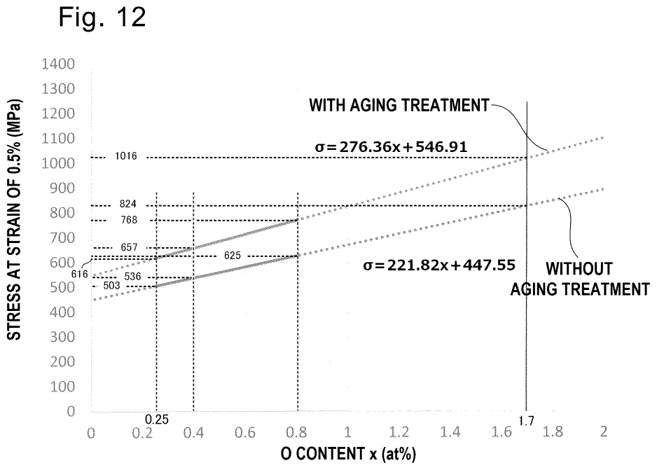

As seen from the analysis by the present inventors based on the above-described experimental results, the stress σ at a strain of 0.5% in the titanium alloy with a chemical composition of Ti-23Ta-3Sn-xO (wherein the O content x satisfies 0.4 (at %)≤x<1.7 (at %)) is approximately represented by a linear function with a variable x. A graph thereof is shown in FIG. 12. In the case of the titanium alloy before the aging treatment (without aging treatment), the stress σ at a strain of 0.5% can be represented by a function σ=221.82x+447.55. In the case of the titanium alloy after the aging treatment, the stress σ at a strain of 0.5% can be represented by a function σ=276.36x+546.91. As seen from FIG. 12, when the O content x is 0.4 (at %), the stress σ at a strain of 0.5% before the aging treatment is 536 (MPa). When the O content x is 1.7 (at %), the stress σ at a strain of 0.5% before the aging treatment is 824 (MPa). Therefore, before the aging treatment, σ satisfies 536≤σ≤824 within the range of 0.4≤x≤1.7. As seen from FIG. 12, when the O content x is 0.4, the stress σ at a strain of 0.5% after the aging treatment is 657 (MPa). When the O content x is 1.7, the stress σ at a strain of 0.5% after the aging treatment is 1,016 (MPa). Therefore, after the aging treatment, σ satisfies 657≤σ≤1,016 within the range of 0.4≤x≤1.7. This verified that the stress o at a strain of 0.5% satisfies at least the range of 536 (MPa)≤σ≤1,016 (MPa) within the range of 0.4≤x≤1.7 before and after the aging treatment.

In consideration of these results, the stress σ at a strain of 0.5% when the test specimen of the titanium alloy with a chemical composition of Ti-23Ta-3Sn-xO (provided that 0.4≤x≤1.7) was subjected to the tensile test is preferably 400 (MPa) or more and 1,200 (MPa) or less, that is, within the range of 400 MPa to 1,200 (MPa) (400 MPa≤σ≤1,200 MPa). The stress σ at a strain of 0.5% is desirably 500 (MPa) or more, and more desirably 530 (MPa) or more. The stress o at a strain of 0.5% is desirably 1,000 (MPa) or less, more desirably 900 (MPa) or less, and still more desirably 830 (MPa) or less.

As a reference, the stress when the permanent set reaches 0.2% (the stress at a strain of 0.2%) is investigated. As seen from FIG. 8(B), the stress at a strain of 0.2% in the test specimen T1 is 490 (MPa). As seen from FIG. 10(B), the stress at a strain of 0.2% in the test specimen T2 is generally 700 (MPa). Therefore, in the titanium alloy with a chemical composition of Ti-23Ta-3Sn-0.8O, the stress at a strain of 0.2% before and after the aging treatment is any value within the range of 490 to 700 (MPa). As seen from FIG. 10(A), the stress at a strain of 0.2% in the test specimen H2 is 500 (MPa), and therefore the stress o at a strain of 0.2% in the titanium alloy with a chemical composition of Ti-23Ta-3Sn-0.25O is 500 (MPa) or less.

The stress at a permanent set of 0.2% is at a region where the stress is likely to vary depending on the test specimen. Therefore the stress at a strain of 0.5% should originally be used in the analysis. If the stress at a permanent set of 0.2% is analyzed, then it is estimated that the stress at a strain of 0.2% in the titanium alloy with a chemical composition of Ti-23Ta-3Sn-xO (provided that 0.4≤σ≤1.7) generally satisfies the range of 400≤σ≤700 (MPa) before the aging treatment. After the aging treatment, it is estimated that the stress at a strain of 0.2% in the titanium alloy with a chemical composition of Ti-23Ta-3Sn-xO (provided that 0.4≤σ≤1.7) generally satisfies the range of 600≤σ≤900 (MPa). Accordingly, before and after the aging treatment, it is estimated that the stress at a strain of 0.2% in the titanium alloy with a chemical composition of Ti-23Ta-3Sn-xO (provided that 0.4≤σ≤1.7) generally achieves a relational expression of 400≤σ≤900.

### Example 3

### Vickers Hardness Test

The inventors of the present application performed a Vickers hardness test on a test specimen T3 of Example 3-1 and a test specimen T4 of Example 3-2 that were produced using the titanium alloy in the embodiment of the present invention in which the content of O was changed. In the Vickers hardness test, the number of measurement points was ten, and a load of 0.1 (N) was applied to the measurement points. A test specimen H3 of Comparative Example 3 was prepared, and the Vickers hardness test was performed in a similar manner.

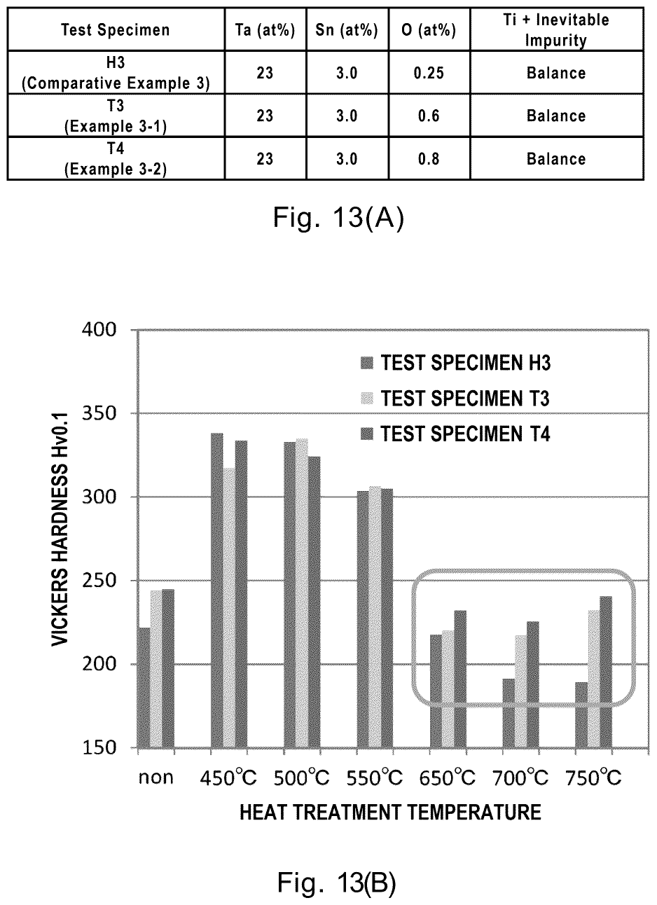

FIG. 13(A) is a table showing the chemical compositions of the test specimens T3, T4, and H3 that are each a subject undergoing the Vickers hardness test. The test specimens T3, T4, and H3 each have a round wire shape with a diameter φ of 0.517 mm. The test specimen H3 was produced using a titanium alloy with a chemical composition of Ti-23Ta-3Sn-0.25O and had a low content of O. The test specimen T3 was produced using a titanium alloy with a chemical composition of Ti-23Ta-3Sn-0.6O. The test specimen T4 was produced using a titanium alloy with a composition of Ti-23Ta-3Sn-0.8O. Test specimens in which the test specimens T3, T4, and H3 were not subjected to a heat treatment and test specimens in which the test specimens T3, T4, and H3 were subjected to a heat treatment at 450° C., 500° C., 550° C., 650° C., 700° C., and 750° C. for 30 minutes were prepared.

FIG. 13(B) shows the results of the Vickers hardness test. As shown in FIG. 13(B), the test specimens T3, T4, and H3 were not largely changed by the heat treatment until a heat treatment temperature of 550° C. On the other hand, it was confirmed that as the content of O is higher in the heat treatment at 650° C. or higher, the hardness of the titanium alloy tends to be higher. Therefore, this shows that when the content of O is increased, the heat treatment temperature is, for example, preferably within the range of 600° C. to 1,000° C., and more preferably within the range of 700° C. to 900° C.

As confirmed from <Tensile Test 1> to <Tensile Test 4> and <Vickers Hardness Test> described above, the elastic limit strain and the strength of the material are enhanced by increasing the content of O. This showed that a proper increase in the content of O led to a titanium alloy having moderate hardness and elastic limit strain that facilitate post-working.

### Method for Producing Titanium Alloy

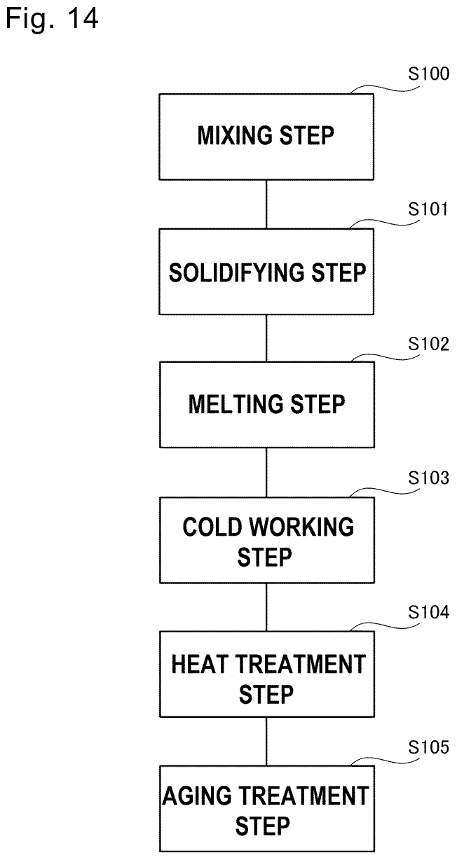

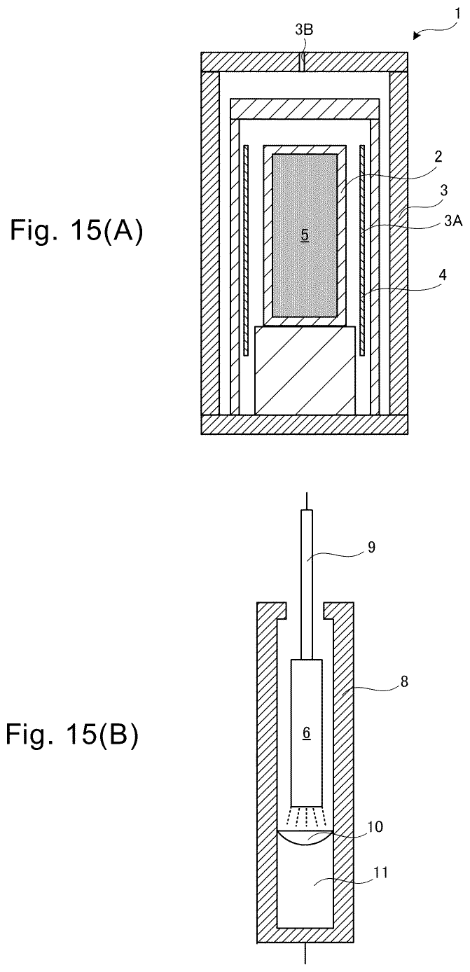

Hereinafter, a method for producing a titanium alloy according to an embodiment of the present invention will be described with reference to the accompanying drawings. Referring to FIGS. 14 and 15, a method for producing a titanium alloy according to the embodiment of the present invention will be described below.

### Mixing Step

First, as shown in FIG. 14, a mixing step is performed which includes preparing a Ti powder containing titanium (Ti) as a main component, a Ta powder containing tantalum (Ta) as a main component, and an Sn powder containing tin (Sn) as a main component, and mixing them at a predetermined mixing ratio (step S100). In the present embodiment, the Ti powder, Ta powder, and Sn powder are each sieved by a sieve having a mesh with any size of 325 (mesh: mesh/inch) or less, so that the powders are assumed to have a grain size (particle diameter) that can pass through the sieve. The above-described Ti powder preferably contains 90% or more of titanium (Ti), more preferably 95% or more of titanium (Ti), and even more preferably 99% or more of titanium (Ti). Here, the remaining components of the Ti powder include components other than titanium (Ti). The titanium (Ti) in the Ti powder may contain pure titanium (Ti) or titanium (Ti) having an oxide film. The above-described Ta powder preferably contains 90% or more of tantalum (Ta), more preferably 95% or more of tantalum (Ta), and even more preferably 99% or more of tantalum (Ta). Here, the remaining components in the Ta powder include components other than tantalum (Ta). The tantalum (Ta) in the Ta powder may contain pure tantalum (Ta) or tantalum (Ta) having an oxide film. The above-described Sn powder preferably contains 90% or more of tin (Sn), more preferably 95% or more of tin (Sn), and even more preferably 99% or more of tin (Sn). Here, the remaining components in the Sn powder include components other than tin (Sn). The tin (Sn) in the Sn powder may contain pure tin (Sn) or tin (Sn) having an oxide film.

At the same weight, a powder having a smaller grain size will have more particles constituting the powder than a powder having a larger grain size. As a result, when compared at the same weight, a powder having a smaller grain size has a larger surface area that reacts with oxygen than a powder having a larger grain size. Titanium powder (Ti) and tantalum powder (Ta) are stabilized in the atmosphere by an oxide film. Consequently, when compared at the same weight, the content of O in the titanium alloy, which is the final product, increases more in a case where the powder contains titanium powder (Ti) or tantalum powder (Ta) with smaller grain size therewith than in a case where the powder contains titanium powder (Ti) or tantalum powder (Ta) with larger grain size. Therefore, the grain size of the titanium powder (Ti) and tantalum powder (Ta) affects the content of O in the titanium alloy, and the content of O in the titanium alloy can be adjusted by appropriately selecting the grain size of each powder. For this reason, in order to provide a plurality of titanium alloys having different oxygen contents, the grain size of at least one of these Ti powder and Ta powder may be changed. If the desired oxygen content cannot be achieved only by reducing the particle diameter of Ti powder and/or Ta powder, titania powder may additionally be mixed therewith since the titania powder itself contains oxygen. It should be noted that although it is possible to change the content of O by changing the grain size of the Sn powder, even if the grain size of Sn powder is adjusted, the content of O in the titanium alloy is hardly affected because the content of the Sn powder is low in the present embodiment.

For example, the Ti powder or titania powder, Ta powder, and Sn powder are uniformly mixed in such mixing ratios that, relative to 100 atomic % (at %) of the entire amount of the titanium alloy, the powder includes 15 to 27 at % of tantalum (Ta), 1 to 8 at % of tin (Sn), 0.4 to 1.7 at % of oxygen (O), and the balance of titanium (Ti) and inevitable impurities. When the contents as above are converted into those by weight basis % and when the content of the alloy as a whole is 100% by weight (wt %), the content of Ta is 40 to 56 wt %, the content of Sn is 2 to 10 wt %, the content of 0 is 0.1 to 0.3 wt %, and the balance includes titanium (Ti) and inevitable impurities. For example, in a case where a titanium alloy of Ti-23.4Ta-3.4Sn-xO is prepared, when the content of the alloy as a whole is 100% by weight, the powders are mixed in such a manner that Ta powder is 52% by weight, Sn powder is 5% by weight, and the balance includes Ti powder or titania powder. Furthermore, the content of O is adjusted by adjusting the grain size of Ti powder or Ta powder that has an oxide film on the surface thereof, or by using a titania powder. In the present embodiment, since the content of Sn powder is small, it is presumed that the effect of the Sn powder on the content of O is small. It should be noted that the indication of at % represents atomic %, and that the indication of at % in the following text is used as representing the atomic% of the corresponding element relative to 100 atomic % (at %) of the entire amount of the corresponding titanium alloy. Furthermore, in the following, a numerical value attached to the element symbols of Ta, Sn or O representing the chemical composition of the titanium alloy (see those in parentheses immediately after the titanium alloy in the following) represents the numerical value of atomic % (at %) of each element (Ta, Sn, O) relative to 100 atomic % (at %) of the entire amount of the titanium alloy.

### Solidifying Step

Next, as shown in FIG. 14, Ti powder or titania powder, Ta powder, and Sn powder that have uniformly been mixed in the above-described mixing step (hereinafter, simply referred to as mixed powder) are placed in a vacuum environment, and the mixed powder is caused to undergo solid-phase diffusion bonding to perform a solidifying step (step S101). By performing the solidifying step, the mixed powder becomes a solidified body. Since the mixed powder is subjected to solid-phase diffusion bonding while being in a state of being placed in a vacuum environment, it is possible to restrict the unexpected oxygen (O) from entering the solidified body from the outside air. Furthermore, in the present embodiment, the solidified body refers to a single mass made of a mixed powder that has undergone solid-phase diffusion bonding. In addition, in the solidifying step, for example, a normal heat treatment (for example, a sintering treatment by heating), a pressurization and heat treatment that simultaneously performs pressurization and heating, or the like is employed. As the pressurization and heat treatment, for example, any of a hot isostatic pressing method (HIP: Hot Isostatic Pressing), a spark isostatic pressing method (SIP: Spark Isostatic Pressing), and a spark plasma sintering method (SPS: Spark Plasma Sintering) is used, and the mixed powder is solidified by any of these methods. Note that HIP and SIP are each a method utilizing isotropic (hydrostatic) pressurization, and SPS is a method utilizing directional pressurization (axial pressurization) because of the use of a press machine and a metal mold. Furthermore, the pressure in a vacuum environment where the mixed powder is placed in the present embodiment is, for example, preferably 1.0×10⁻¹ (Pa) or less, more preferably within the range of 1.0×10⁻² to 1.0×10⁻⁵ (Pa), and further preferably within the range of 1.0×10⁻² to 1.0×10⁻³ (Pa).

Here, referring to FIG. 15(A), a case where a process by a hot isostatic pressing method is used in the solidifying step (hereinafter, referred to as an HIP process) will be described as an example. First, the mixed powder 5 described above is pressurized and filled into an HIP container 2. The HIP container 2 is composed of, for example, a lid and a cylindrical container in which the face on one end is open and the other end face side is closed. The cylindrical container is filled with the mixed powder 5 while being compressed, and the cylindrical container is placed in a vacuum chamber of an electron beam apparatus (not shown). Then, the pressure in the vacuum chamber is put in a vacuum state within the range of 1.0×10⁻² to 1.0×10⁻³ (Pa), and electron-beam welding is performed to weld the lid to the opening of the HIP container 2 so as to hermetically seal the HIP container 2. As a result, the mixed powder is placed in a vacuum environment within the HIP container 2.

The material of the HIP container 2 is preferably a material other than Ta, but Ta is very expensive and is not practical for use in mass production. For this reason, for example, a material containing Ti or iron as a main component is preferably used as the material of the HIP container 2, and a material containing iron as a main component is more preferably used. Note that, in a general HIP process, the HIP container 2 is produced by using the same material as the material having the highest melting point in the mixed powder 5 (here, this material would be Ta).

Then, the HIP container 2 is installed inside a heat insulating portion 3A of an HIP furnace 3 of an HIP device 1. Note that the HIP device 1 is configured so that the inner area of the heat insulating portion 3A of the HIP furnace 3 can be brought into a high-temperature and high-pressure atmosphere by practically inert gasses such as argon and the heating of the heater 4. Furthermore, the gas is supplied to the inside of the HIP furnace 3 from the outside through a gas introduction passage 3B of the HIP furnace 3. When a high temperature and a high pressure are applied to the HIP container 2 for a predetermined period of time, the mixed powder 5 is pressurized and heated through the HIP container 2. As a result, the mixed powder 5 becomes a solidified body that has undergone solid-phase diffusion bonding. Note that, since the mixed powder 5 is sealed in the HIP container 2 in a state of vacuum, even if the mixed powder 5 is pressurized and heated through the HIP container 2, it is possible to restrict the unexpected oxygen (O) from entering the solidified body from the outside air. Incidentally, immediately after the HIP treatment, the HIP container 2 and the solidified body are firmly bonded. Therefore, in order to separate the HIP container 2 and the solidified body from each other, the HIP container 2 and the layer in which the solidified body is mixed with the HIP container 2 are cut by a machine tool. As a result, only the solidified body remains. Consequently, a solidified body with a cylindrical shape is formed.

In the HIP treatment, the temperature inside the HIP furnace 3 of the HIP device is increased, for example, at 1,000° C., and the pressure is adjusted to 98 MPa. The HIP container is placed under these conditions for a predetermined period of time to form a solidified body. The temperature of the inside of the HIP furnace 3 may be any temperature as long as the HIP container 2 is not damaged or melted. The temperature of the inside of the HIP furnace 3 is preferably, for example, 700° C. to 1,600° C., more preferably 900° C. to 1,400° C., and still more preferably 1,000° C. to 1,200° C. The pressure of the inside of the HIP furnace 3 is preferably 50 to 200 (MPa), more preferably 70 to 180 (MPa), and still more preferably 90 to 120 (MPa).

The melting point of Ta is as high as 3,017° C.

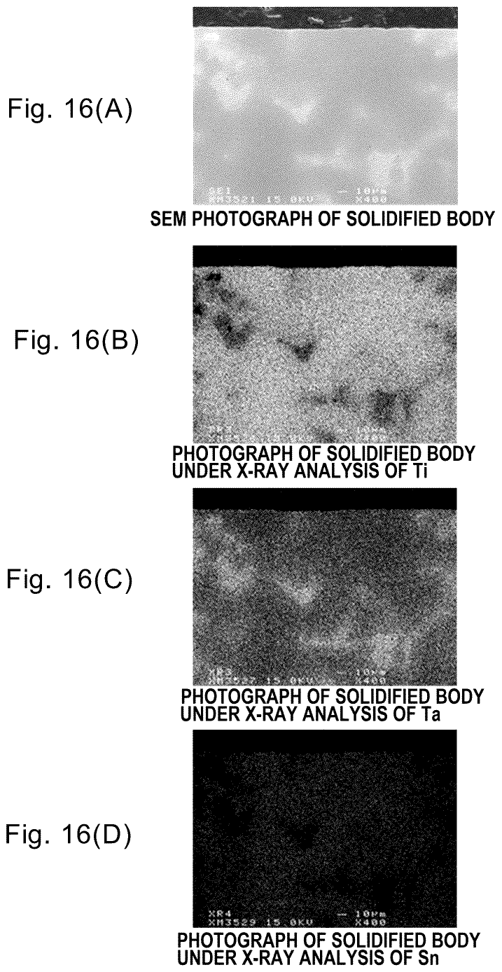

Even if the inside temperature of the HIP furnace 3 is set to, for example, about 900° C. to 1,400° C., when the content ratio of Ta is a high content ratio of 15 at % or more as in the titanium alloy of the present embodiment, there is a low probability that the respective powders will be diffused in a completely uniform manner. That is, the solidified body generated by the HIP process may be configured such that Ta, Sn, Ti, and O are not uniformly diffused, and may include regions where Ta, Sn, Ti or O is unevenly distributed. In order to confirm this matter, the inventors of the present application set the inside temperature of the HIP furnace 3 to 1,000° C. and the inside pressure of the HIP furnace 3 to 98 MPa and produced a solidified body from the mixed powder as described above (the content of Ta powder was 23.4 at %, the content of Sn powder was 3.4 at %, the balance was Ti powder, and the grain size of each powder was 10 to 45 μm). At that time, the inventors investigated how Ta, Sn, and Ti were distributed in the solidified body using a scanning electron microscope (SEM) and X-rays. The results are shown in FIGS. 16(A) to (D). FIG. 16(A) is a photograph of a SEM image when the solidified body is observed at a magnification of 400 using a scanning electron microscope (SEM). As shown in FIGS. 16(B) to (D), Ti, Ta, and Sn in the range of the SEM image of FIG. 16(A) are not uniformly distributed, and thus, this shows that the Ti powder, Ta powder, and Sn powder are not uniformly diffused. From the above results, it was actually confirmed that it is unlikely that Ti powder, Ta powder, and Sn powder will completely diffuse and alloy with each other in this composition, which has a very high percentage of Ta even when the inside temperature of the HIP furnace 3 is about 900° C. to 1,400° C.

On the other hand, if the inside temperature of the HIP furnace 3 is set to a temperature higher than the above-described temperature, the HIP container 2 itself would be damaged, and consequently, the HIP furnace 3 itself is likely to fail. It is also conceivable to form the HIP container 2 with a material capable of withstanding a high temperature (for example, Ta) in order to realize heating at a temperature higher than 1,400° C. However as described above, if the HIP container 2 is made of a Ta material, it is extremely expensive and thus not practical.

### Melting Step

Next, as illustrated in FIG. 14, the melting step of melting the solidified body of the mixed powder solidified in the solidifying step is performed (step S102). The solidified body is melted by the melting step to become an ingot of a titanium alloy. As described above, although the respective components are not uniformly diffused, the solidified body is subjected to the melting step to fuse (melt) the respective components uniformly, so that it is possible to obtain an ingot of a titanium alloy in which the respective components are uniformly dispersed. In order to simultaneously melt and uniformly diffuse Ta, Sn, and Ti, having respective different melting points, in the melting step, it is preferable to melt the solidified body at a temperature at which all of Ta, Sn, and Ti can be melted at the same time. In the melting step, for example, any of methods including a vacuum arc remelting method (VAR: Vacuum Arc Remelting), an electroslag remelting method (ESR: ElectroSlag Remelting), a vacuum induction melting method (VIM: Vacuum Induction Melting), a cold crucible induction melting method (CCIM: Cold Crucible Induction Melting), a plasma arc melting method (PAM: Plasma Arc Melting), and an electron-beam melting method (EBM: Electron Beam Melting) is used. Thus, the solidified body is melted by any of these methods.

Here, referring to FIG. 15(B), a case where a vacuum arc remelting method (VAR) is used in the melting step will be described as an example. First, a cylindrical solidified body provided in the solidifying step is connected to a rod 9 suspended in an arc melting furnace 8 to serve as a consumable electrode 6. As a result, the consumable electrode 6 is suspended and supported by the rod 9 in a state in which a molten metal pool 10 is positioned directly below the consumable electrode 6 in the arc melting furnace 8. In this state, when a current flows through the consumable electrode 6 via the rod 9, an arc discharge occurs between the consumable electrode 6 and the molten metal pool 10. Due to high heat generated by the arc discharge, the consumable electrode 6 is heated, melted, and consequently made to accumulate directly below to become an ingot 11 of a titanium alloy.

Note that the ingot 11 of the titanium alloy may be connected to the rod 9 as a consumable electrode 6, and then installed in the arc melting furnace 8 as described above. After that, a current may be flown therethrough to melt the ingot 11 again. Then, additional repetitions of this process may be performed because the reliability with which the respective components homogenize can be increased by performing the process a plurality of times. As described above, a titanium alloy is provided.

### Cold Working Step

Next, as illustrated in FIG. 14, cold working is performed on the ingot of the titanium alloy provided in the above-described melting step (step S103). By performing the cold working of the ingot of the titanium alloy, a workpiece of the titanium alloy, such as a wire or a rod, is formed.

### Heat Treating Step

Next, as illustrated in FIG. 14, the heat treating step of heat treating the workpiece made of the titanium alloy provided in the cold working step is performed (step S104). The heat treatment temperature is preferably, for example, 600° C. to 1,000° C., and more preferably 700° C. to 900° C. Note that the heat treating step may be omitted.

### Aging Step

Next, as illustrated in FIG. 14, the aging step of performing an aging treatment on the titanium alloy that has been subjected to the heat treatment in the above-described heat treating step, or on the titanium alloy having been subjected to the cold working step but not to the heat treating step is performed (step S105). The aging treatment temperature is preferably 200° C. to 550° C., and more preferably 300° C. to 500° C. When the aging treatment is performed on the titanium alloy in the present embodiment for a predetermined period of time, the equiaxed α phase or the like is precipitated on the titanium alloy. The α phase is not limited to the equiaxed structure, and may include other embodiments.

Note that, although a description has been given also in the description of the third titanium alloy illustrated in FIGS. 5(A) and (B) produced by the present production method, if the titanium alloy has the same chemical composition, the precipitation amount of the equiaxed α phase increases with higher aging treatment temperature. Along with this, the average particle diameter of the precipitated equiaxed α phase and the area occupancy of the equiaxed α phase increase.

Then, although the following is a repeated description, a general titanium alloy also contains a small amount of oxygen as inevitable impurities. In this case, the content of O is 0.2 at % or less relative to 100 at % of the entire amount of the titanium alloy. In such a titanium alloy, Ta functions as a β stabilizing element to a larger degree than O does as an α stabilizing element. Consequently, the equiaxed α phase is not easily precipitated even by performing an aging treatment. In some cases, the precipitation of the equiaxed α phase may require an aging treatment over several days. On the other hand, the present production method can actively increase the content of O. When the content of O reaches 0.4 at %, O functions as an a stabilizing element. As a result, the minimum amount of the equiaxed α phase is precipitated by an aging treatment of 12 hours and furthermore, a sufficient amount of the equiaxed α phase is precipitated by an aging treatment of 24 hours. Furthermore, when the content of 0 in the titanium alloy reaches 1.7 at %, O as an α stabilizing element functions sufficiently, and a sufficient amount of the equiaxed α phase is precipitated even by the aging treatment of 1 hour. Therefore, the aging treatment time is preferably within the range of 1 to 24 hours, and more preferably within the range of 1 to 4 hours.

The method for producing the titanium alloy according to the present invention is not limited to the above-mentioned embodiment, and for example, together with the tantalum (Ta) powder or in place of the tantalum (Ta) powder, a powder (5a group powder: vanadium group powder) constituted of vanadium (V) or niobium (Nb) which is another element of the vanadium group (5a group element: vanadium group element) may be used. In other words, the chemical composition of the titanium alloy may contain vanadium (V) or niobium (Nb), which is another element of the vanadium group, together with tantalum (Ta) or in place of tantalum (Ta). The titanium alloy obtained by the present production method makes the quality of the product extremely stable. Incidentally, vanadium (V) or niobium (Nb) also has a high melting point similar to that of tantalum, and therefore, it is difficult to guarantee the quality of the metal component after cold working because the internal composition of the titanium alloy is likely to be uneven when only solid-phase diffusion bonding takes place.

However, the melting points of V, Nb, and Ta are 1,910° C., 2,477° C., and 3,017° C. in this order, respectively, and the melting point of titanium is 1,668° . That is, the melting point of V is slightly higher than the melting point of titanium, but the melting points of Nb and Ta are about 1.5 or more times higher than the melting point of titanium. For this reason, it is presumed that the degree of diffusion non-uniformity of Nb and Ta in the solidifying step is greater than that of V. Consequently, Nb, like Ta, can show a distribution similar to that illustrated in FIG. 3 in the solidifying step. Therefore, it can be said that it is of particular importance, as compared with V, that Nb and Ta are homogenized in the melting step.

It should be noted that the titanium alloy and the method for producing a titanium alloy according to the present invention are not limited to the above-mentioned embodiments, and it is of course possible to make various modifications within the scope without departing from the gist of the present invention. For example, conventionally known methods can be used as a method for forming a medical guidewire, a delivery wire, a stent, a clip, an aneurysm embolization coil or a vein filter, or a dental cleanser, a reamer, a file, an orthodontic wire, or the like from the titanium alloy according to the present invention. Examples of the methods include a wire drawing processing, a drawing processing, casting, forging, and a press working.

### INDUSTRIAL APPLICABILITY

The titanium alloy according to the present invention can be utilized in the catheter field such as a guidewire, a delivery wire, a stent, a clip, an aneurysm embolization coil, or a vein filter for medical care, in the dental field such as a cleanser, a reamer, a file or an orthodontic wire for dental treatment, in the orthopedic field such as an artificial bone, and the like.

### REFERENCE SIGNS LIST

1 HIP device
2 HIP container
3 HIP furnace
3A heat insulating portion
3B gas introduction passage
4 heater
5 mixed powder
6 consumable electrode
8 arc melting furnace
9 rod
10 molten metal pool
11 ingot

1. A titanium alloy comprising, relative to 100 atomic % (at %) of an entire amount of the titanium alloy:
15 to 27 at % of tantalum (Ta);
1 to 8 at % of tin (Sn);
0.4 to 1.7 at % of oxygen (O): and
a balance of titanium (Ti) and inevitable impurities.

2. The titanium alloy according to claim 1, having an equiaxed α phase, an average particle diameter of the equiaxed a phase falling within a range of 0.01 μm to 1.0 μm.

3. The titanium alloy according to claim 1, having an equiaxed α phase, an area occupancy at which the equiaxed α phase occupies in a cross-section per unit area falling within a range of 0.1% to 10%.

4. The titanium alloy according to claim 1, wherein
when a stress when a permanent set reaches 0.5% in a tensile test is defined as a stress at 0.5% strain,
the stress at 0.5% strain falls within a range of 400 MPa to 1,200 MPa.

5. A method for producing a titanium alloy comprising:
a mixing step of mixing at least a titanium powder, which contains titanium (Ti) as a main component, and a vanadium group powder, which contains a vanadium group element as a main component, to obtain a mixed powder;
a solidifying step of heating the mixed powder mixed in the mixing step to cause solid-phase diffusion bonding to thereby obtain a solidified body; and
a melting step of heating and melting the solidified body to generate a titanium alloy.

6. The method for producing a titanium alloy according to claim 5, wherein
in the solidifying step, the solid-phase diffusion bonding of the mixed powder is performed by heating the mixed powder at any temperature between 900 to 1,400° C.

7. The method for producing a titanium alloy according to claim 5, wherein
in the solidifying step, the mixed powder is placed in a vacuum environment, and the solid-phase diffusion bonding of the mixed powder is performed by heating and pressurizing the mixed powder.

8. The method for producing a titanium alloy according to claim 5, wherein
in the melting step, the solidified body is melted by a vacuum arc remelting method or a cold crucible induction melting method.

9. The method for producing a titanium alloy according to claim 5, wherein
the titanium alloy contains 0.4 to 1.7 at % of oxygen (O) relative to 100 atomic % (at %) of an entire amount of the titanium alloy.

10. The method for producing a titanium alloy according to claim 5, wherein
the vanadium group powder contains tantalum (Ta) or niobium (Nb) as a main component.

11. The method for producing a titanium alloy according to claim 5, wherein
the titanium alloy contains 1 to 8 at % of tin (Sn) relative to 100 atomic % (at %) of an entire amount of the titanium alloy.

12. The method for producing a titanium alloy according to claim 5, comprising:
a heat treating step of subjecting the titanium alloy produced in the melting step to a heat treatment; and
an aging step of subjecting the titanium alloy having been subjected to the heat treatment to an aging treatment, wherein
the titanium alloy after the melting step includes, relative to 100 atomic % (at %) of an entire amount of the titanium alloy, 15 to 27 at % of tantalum (Ta), 1 to 8 at % of tin (Sn), 0.4 to 1.7 at % of oxygen (O), and a balance of titanium (Ti) and inevitable impurities.

13. The method for producing a titanium alloy according to claim 12, wherein
the titanium alloy is subjected to an aging treatment of 24 hours or less in the aging step, so that an α phase is caused to precipitate in the titanium alloy.
